(19) United States
(12) Patent Application Publication
(10) Pub. No.: US 2005/0209933 A1
(43) Pub. Date: Sep. 22, 2005

(54) Graphical paging unit, a system including graphical paging units and the use of those

(76) Inventor: David Scott Thompson, Candler, NC (US)

Correspondence Address: PAUL H. DEMCHICK;PROFESSOR DEMCHICK'S PATENT SERVICES, THE JACOB TOMLINSON HOUSE, 407 WEST BROAD STREET, WILSON, NC, 27893, US

(21) Appl. No.: 10/805,077

(22) Filed: Mar. 20, 2004

(51) Int. Cl. G06F 17/60

(52) U.S. Cl. 705/27; 705/14

(57) ABSTRACT

Graphical Paging Unit, a System Including Graphical Paging Units and the Use of Those. The invention disclosed here includes a graphical dedicated receiving unit, a patron paging system with improved capabilities and a method for using that system to deliver marketing messages to waiting patrons as well as to perform other functions. The object of this system and its use are to provide a superior experience for waiting patrons and allow the advantage to the establishment of allowing marketing. That marketing may include messages promoting the establishment using the system or other establishments. Some embodiments of the invention include other features.

### CROSS-REFERENCE TO RELATED APPLICATIONS

Not applicable

### STATEMENT REGARDING FEDERALLY SPONSORED RESEARCH OR DEVELOPMENT REFERENCE TO SEQUENCE LISTING, A TABLE, OR A COMPUTER PROGRAM LISTING COMPACT DISK APPENDIX

Not applicable

### BACKGROUND OF THE INVENTION

The term “local wireless communication system” is taken here to refer to a system including at least one non-mobile transmitter and at least one mobile receiving unit in which no non-mobile transmitter which is part of that system is more than 4 km from any other non-mobile transmitter which is part of that system. The term “dedicated receiving unit” refers to a mobile receiving unit which is only intended for use with a particular local wireless communication system. “Patron paging system” is taken here to mean a system that uses wireless communications to one or more dedicated receiving units to notify at least one waiting patron when that patron's wait is over. Ways dedicated receiving units notify patrons that the wait is over include, but are not limited to, illumination of one or more lights, generation of sound, and/or vibration. “Graphical display” is taken here to mean a display capable of displaying any pattern of pixels specified in a received signal. This is specifically distinct from a display in which patterns are limited to a set of predetermined characters (such as an alphanumeric display). “Graphical dedicated receiving unit” is taken here to mean a dedicated receiving unit equipped with a graphical display. The pattern of pixels displayed on the graphical dedicated receiving unit at any given time is referred to here as a “screen-slide.”

Patron paging systems have become commonplace. For example, many restaurants lend waiting patrons dedicated receiving units that can be used to inform a selected patron when a table is available for that patron. Patron paging systems have also been deployed in other settings (e.g., libraries, malls) in which patrons are required to wait. Advantages afforded establishments employing patron paging systems include elimination of the need for noisy public address paging, elimination of chaotic and unsightly queuing of patrons, improved customer satisfaction and reduction of employee labor required in managing and tending to waiting patrons.

Patron paging systems may also serve additional functions. For example, U.S. Pat. No. 6,573,824 issued to Lovegreen, et al discloses, in brief, a patron paging system which also serves as a gaming system. This has the advantage of entertaining patrons who are waiting. For another example, some dedicated receiving units are designed to facilitate their use as under-drink coasters during the wait.

Presenting marketing messages to waiting patrons can accomplish marketing aims. Ideally, it will also help patrons pass the time. Some use has been made of the ability of patron paging systems to serve marketing aims. Typically, this has been accomplished by placing printed marketing materials directly on the exterior of the dedicated receiving units or associating printed marketing material with the dedicated receiving units. For example, several companies distribute “paddle type” pagers which allow a printed advertising message the size of a standard business card to be displayed in the advertising area attached to the dedicated receiving unit. One example of such a unit is sold under the name AdverTeaser by Long Range Systems, Inc.

Various uses of wireless communication to deliver marketing messages have been used or disclosed. For example, U.S. Pat. No. 6,636,835 issued to Ragsdale-Elliott, et al. discloses a system which, in addition to other capabilities, allows seated customers to be shown advertisements on the screen of a terminal located at the patron's table.

Systems are known which allow restaurant customers to communicate with the restaurant establishment using patron processed units which are not dedicated receiving units. For example, U.S. Pat. Publication 2002/0133418A1 by Hammond, et al. discloses a system which uses personal digital assistants (PDAs). The use of those devices is somewhat costly. The risk of theft of such devices is also increased by the expectation by patrons that such devices would be usable if stolen.

### BRIEF SUMMARY OF THE INVENTION

The invention disclosed here includes a graphical dedicated receiving unit, a patron paging system with improved capabilities and a method for using that system to deliver marketing messages to waiting patrons as well as to perform other finctions. The object of this system and its use are to provide a superior experience for waiting patrons and allow the advantage to the establishment of allowing marketing. That marketing may include messages promoting the establishment using the system. That marketing may include messages promoting other establishments. Some embodiments of the invention include other features.

### BRIEF DESCRIPTION THE DRAWINGS

FIG. 1 is a simplified depiction of a typical layout of the face of a graphical dedicated receiving unit of the preferred embodiment.

FIG. 2 is similar to FIG. 1. However, typical printed markings on the membrane overlay are shown.

FIG. 3 is a simplified depiction of a typical layout of the face of a base station of the preferred embodiment.

FIG. 4 is a schematic representation of a typical patron paging system including graphical dedicated receiving units.

FIG. 5 is a schematic representation of the typical flow of information for images and sounds from the mind of the presentation developer to the graphical dedicated receiving units in the situation in which the computer running the presentation composing software and the base station of the patron paging system are directly connected by wire.

FIG. 6 is a schematic representation of the typical flow of information for images and sounds from the mind of the presentation developer to the graphical dedicated receiving units in the situation in which the computer running the presentation composing software and the base station of the patron paging system are connected remotely by telephone lines.

### DETAILED DESCRIPTION OF THE INVENTION

The preferred system embodiment of the invention is a system comprising one base station and a plurality of graphical dedicated receiving units.

Those graphical dedicated receiving units of the preferred embodiment are battery operated, hand held units with a graphical display, 8 megabits of memory and a RF modem. Each graphical dedicated receiving unit is a computer controlled synthesized FM transceiver capable of both standard modulation and frequency hopping modulation. The frequency range of this preferred embodiment is 902-928 MHz. The graphical display is a 128×64 blue liquid crystal which is backlit by light emitting diodes. The contrast of the graphical display is digitally controlled. The RF modem of each graphical dedicated receiving unit has a transfer rate of 300 baud to 19,200 baud. The RF modem of each graphical dedicated receiving unit has a sensitivity of −110 dBm at 2400 baud and an RSSI sensitivity of −105 dBm. Each graphical dedicated receiving unit contains an electronic Ser. No. for unique identification. Each graphical dedicated receiving unit of this preferred embodiment has a plastic casing (PacTec RF35, black).

In the preferred embodiment, each graphical dedicated receiving unit has four illuminated button switches which allow the patron to communicate with the system. These communications could serve many purposes, including, but not limited to, ordering drinks to be consumed while waiting for a table or pre-ordering menu items to be consumed at the table once seated. Whether these buttons are used and the exact nature of the potential use of the buttons by the customer is determined by the programming and is at the pleasure of the establishment employing the system. The switches of the preferred embodiment are of the switch membrane overlay type.

The illuminated buttons could also allow the patron to play games. Again, whether to offer this option and exactly which games to offer is the choice of the establishment employing the system. These games could be individual games in which only the system and the patron holding the unit interact. These games could involve multiple patrons playing in an interactive way.

The illuminated buttons could also allow the patron to select specific information to access. Again, whether to offer this option and exactly which information to offer, is the choice of the establishment employing the system.

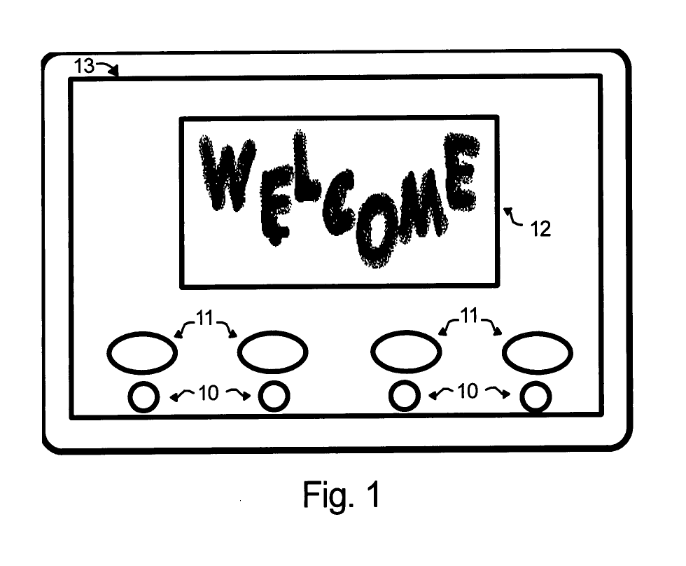

FIG. 1 is a simplified depiction of a typical layout of the face of a graphical dedicated receiving unit of the preferred embodiment. Referring to FIG. 1, within the membrane overlay 13, each membrane overlay switch 11 is near a corresponding region 10 which is able to be backlit by light emitting diodes. The “welcome” graphic pictured on the graphical display 15 is merely by way of example.

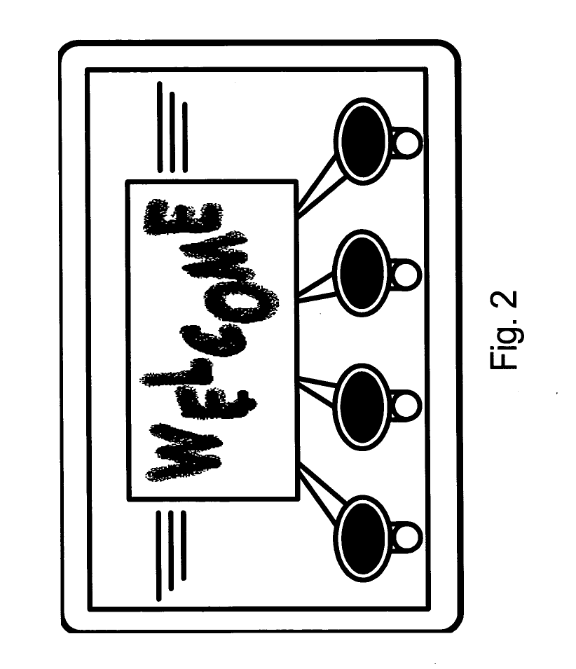

FIG. 2 depicts the face of a graphical dedicated receiving unit of the preferred embodiment. The depiction is similar to that of FIG. 1. However, the printed markings on the face have been included. The markings, in addition to being ornamental, clarify relationships for the user. The makings make clear the relationship of each switch to the corresponding region which is able to be backlit. The markings also visually connect each switch with a specific point at the edge of the graphical display. That is valuable for indicating to the user a meaning for each switch.

The graphical dedicated receiving units of this preferred embodiment are equipped with a piezoelectric sounder. That piezoelectric sounder can be used to aid in notifying a patron when that patron's wait is over or may be used to create music (or other sounds) to make the presentation of the screen-slides more interesting for the waiting patron.

This preferred system embodiment also has security encryption to protect the privacy of information being transmitted. This is especially useful when information such as account numbers is transmitted.

The graphical dedicated receiving units of this preferred embodiment can be fabricated using readily available components. The following examples of key components which can be used are included here by way of example. However, it will be readily apparent to those skilled in the art that other specific components could be substituted. Except as noted, a single one of each item is used in fabricating each graphical dedicated receiving unit. Except for the power source, each general description is followed by a supplier and part designation.
a. Power source (2/unit): 1.2 volt Nickel metal hydride cells (AAA), 650 mAh
b. Blue light emitting diodes (4/unit): eled.com EA3528PCB
c. Piezoelectric sounder: Murata PKM22EPP-4001
d. 8-Bit Flash microcontroller: Motorola MC68HC908GT16
e. Voltage regulator: National Semiconductor LP2981IM5-3.0
f. Transceiver: Chipcon CC1000
g. Liquid crystal display: Optrex F-51320GNB-LW-AB
h. Step-Up DC-DC Converter: Maxim MAX1676
i. 8 Megabit Boot Sector Flash Memory: Advanced Micro Devices Am29F800B

Another embodiment of the graphical dedicated receiving unit is similar to that of the preferred embodiment except that the display on each graphical dedicated receiving unit is multicolor.

The amount of memory in each graphical dedicated receiving unit of the preferred embodiment is sufficient to hold the information for several hundreds of screen-slides (the exact number would vary depending on other information stored in the device. Alternative embodiments have less memory (e.g., Am29F200B or Am29F400B instead of Am29F800B) as a means of further economizing.

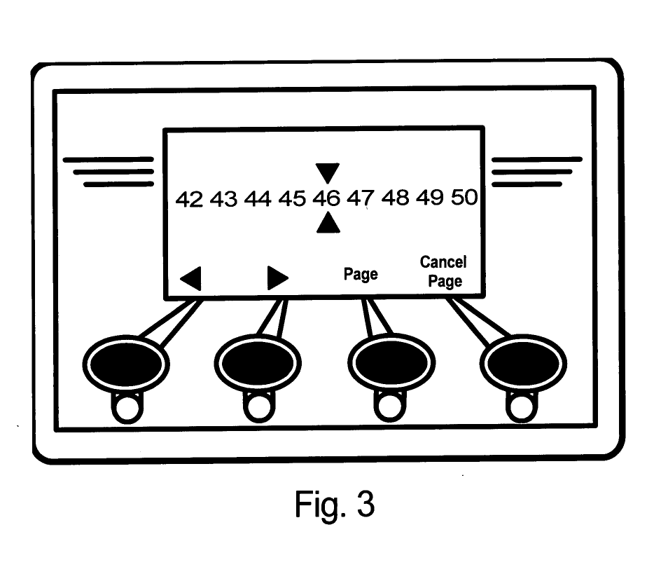

The base station of the preferred embodiment is similar to the graphical dedicated receiving units. However, the base station has an external antenna and its own plug-in power supply. The central unit of the base station of the preferred embodiment is depicted as FIG. 3. The display of the base station of the preferred embodiment would indicate that a leftward arrow, rightward arrow, the word “Page” and the words “Cancel Page” each correspond to a different specific switch. The principle use of the graphical display on the base station is to allow the selection by the user of specific graphical dedicated receiving units. As each graphical dedicated receiving unit is removed from the base station, the number associated with that unit is automatically added to the list of units to be displayed. Similarly, as each graphical dedicated receiving unit is returned to the base station, the number associated with that unit is automatically deleted from the list of units to be displayed. The use of the buttons labeled with imprinted arrows scrolls the list of graphical dedicated receiving unit numbers to the left or right. Pressing the “Page” button causes the sending of an appropriate signal to the graphical dedicated receiving unit the number of which is aligned between the arrow icons on the graphical display. Likewise, pressing the “Cancel Page” button causes the sending of an appropriate signal to the graphical dedicated receiving unit the number of which is aligned between the arrow icons on the graphical display. The number associated with a graphical dedicated receiving unit which has been paged is displayed alternating with a “P” on the display. The base station of this preferred embodiment has a connection to an external antenna. The base station has a RS-232 serial port to allow connection to either a computer (e.g. a PC) or a telephone line. This allows upload and download of information from the base station. The RS-232 serial port interface is shared with the RF modem serial port on the microcontroller. The base station of the preferred embodiment also includes cradle holders for graphical dedicated receiving units which are charging. Each graphical dedicated receiving unit of the preferred embodiment is equipped with charger circuitry. Therefore, the charging station merely supplies 5.7 volts to each unit while that unit is on its cradle.

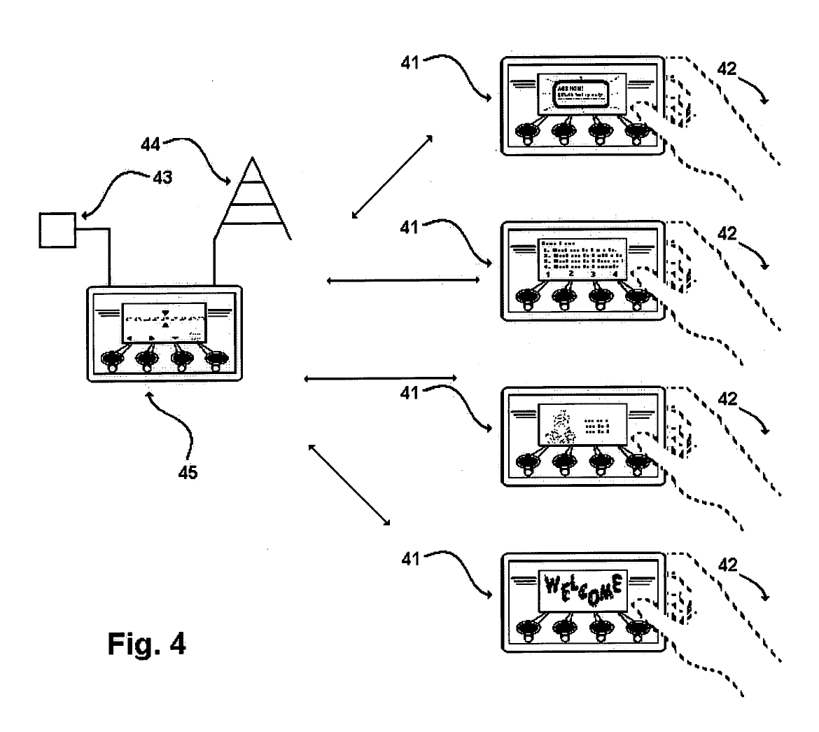

FIG. 4 is a schematic representation of the system of the preferred embodiment. For illustration, four graphical dedicated receiving units 41 are shown. The hands 42 are shown environmentally and are not themselves part of the invention. The specific number of units would vary and would, in most cases, be higher than four. The base station 45 is connected to an external antenna 44 and a phone line or computer 43. The straight arrows between the base station and each of the graphical dedicated receiving units represent the two way RF communication possible in the preferred embodiment.

The graphical dedicated receiving units used in the systems disclosed here are reasonably inexpensive and less expensive than similar non-dedicated devices. However, significant losses of units due to theft would render them impractical for an establishment to employ. Therefore the preferred embodiment of this invention has several antitheft features. In addition, the dedicated nature of the units makes them less attractive as the targets of theft than non-dedicated units. The preferred embodiment of the graphical dedicated receiving units is appropriately styled, to look little like tempting targets for theft (e.g., PDAs). The lack of external input/output ports on the preferred embodiment would make it clear that the dedicated graphical receiving unit would serve little value to anyone stealing it.

Additional antitheft features of the preferred system embodiment of this invention are based on polling signals. The base station of the preferred embodiment frequently polls each graphical dedicated receiving unit on the list of units away from the base station. If a pager has not received a polling signal within a predetermined time, appropriate graphical messages will be displayed encouraging the patron to bring the graphical dedicated receiving unit closer to the establishment. These graphical messages encouraging the patron to bring the graphical dedicated receiving unit closer to the establishment can also be accompanied by appropriate sounds. If a graphical dedicated receiving unit continues not received a polling signal for a predetermined time, the graphical dedicated receiving unit ceases functioning. When a graphical dedicated receiving unit ceases functioning in this manner it can only be restored to function by receiving a polling signal from its base station. Similarly, when a graphical dedicated receiving unit has power interrupted (e.g. the batteries are removed and then replaced) it can only be restored to function by receiving a polling signal from its base station. When any graphical dedicated receiving unit fails to acknowledge a polling signal, establishment personnel are notified of this by a short sound notification and an appropriate message on the display. This gives establishment personnel the option of investigating the disappearance of the graphical dedicated receiving unit.

The polling signal exchanged between the based station and the graphical dedicated receiving units has uses in addition to the antitheft measures described above. The base unit records each pager unit's poll acknowledgment RSSI level and then returns it to the pager on the next poll. This allows the graphical dedicated receiving unit to dynamically adjust its transmission power level between 0.01 milliwatt and 10 milliwatt. Based on testing, the graphical dedicated receiving units of the preferred embodiment can operate approximately 12 hours between charges. However, that can vary considerably. One factor that influences the length of time each unit can operate between charges is the distance between each graphical dedicated receiving unit and the base station.

This preferred embodiment of the system also notifies the patron when a graphical dedicated receiving unit's batteries are nearly in need of recharging. The polling exchanges also allow establishment personnel to be notified when a graphical dedicated receiving unit's batteries are nearly in need of recharging. The preferred embodiment of the system automatically charges the graphical dedicated receiving units when they are returned to the base station. The nature of flash memory allows information held in the memory of the graphical dedicated receiving unit to be maintained even if the charge of the power cells is depleted.

In the preferred embodiment, each graphical dedicated receiving unit maintains an internal non-volatile almanac. The almanac is stored in flash memory and is used to evaluate the performance and status of each unit. Information in the almanac includes a status byte, power cell charge “high water mark,” power cell charge “low water mark,” battery run timer, contrast setting for the LCD and unit ID number.

An alternative embodiment of the graphical dedicated receiving unit disclosed here is equipped with a vibrator which may be used to notify patrons of events such as the availability of a table.

There are frequently advantages to operating a local area network using a standard protocol such as Institute of Electrical and Electronic Engineers (IEEE) 802.11. The preferred embodiment used a non-standard, system specific protocol.

The preferred embodiment of the graphical dedicated receiving unit is controlled by up-loadable software. This makes the preferred embodiment of the graphical dedicated receiving unit very flexible in term of operation. The preferred embodiment of the software, among other functions, controls the presentation of the screen-slides and any sounds to be created by the piezoelectric sounder. The software of this preferred embodiment facilitates simple screen-slide changes, scrolling, peeling and fading. The software of this preferred embodiment also facilitates real time updating specific information. By way of illustration, that information which is updated in real time can include news, sports, weather and specials.

The specific format of the graphical and sound information uploaded to the graphical dedicated receiving unit must be compatible with the specific software being used by the graphical dedicated receiving unit. In the preferred management of the system separate file composer software is used to create appropriately formatted information for uploading to the graphical dedicated receiving units. The preferred composer software uses Ringing Tones Text Transfer Language (RTTTL) to for input of sound creation information. This language is an open standard. One example of RTTTL use is Nokia cellular phones. The preferred composer software can accept standard image file formats (e.g. bitmaps). The images and sound information are converted by composer software by file formats that are compatible with the software uploaded in the graphical dedicated receiving unit. The preferred composer software also allows the operator to select the mode (e.g. peeling) for each screen-slide change.

In this preferred embodiment, information (software or image and sound information) are updated in the graphical dedicated receiving units by wireless communication from the base station. At the operator's pleasure, the updating can happen immediately or upon return of the graphical dedicated receiving unit to the base station.

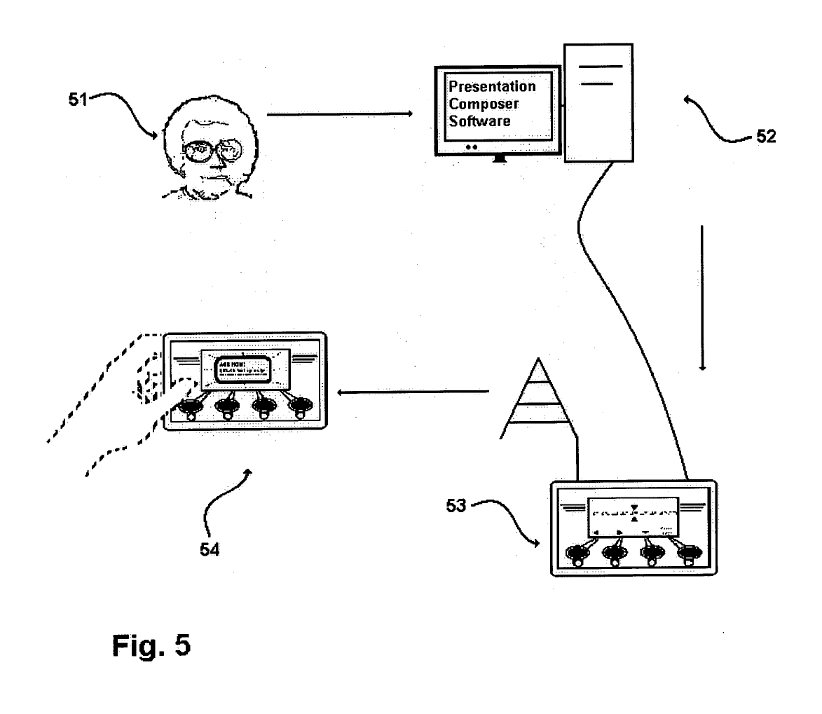

FIG. 5 is a schematic representation of the typical flow of information for images and sound from the mind of the presentation developer to the graphical dedicated receiving units in which the computer running the presentation composing software and the base station of the patron paging system are directly connected by wire. Referring to FIG. 5, the straight arrows represent the flow of information. The presentation developer 51 composes the images and sounds or imports images and sound stored in other formats. This information transfer in accomplished by normal means such as keystrokes and mouse movements and clicks. The developer selects the mode (e.g. peeling) for each screen-slide change. Once the information is formatted correctly by the computer 52 running the composer software, the information is transferred from the computer to the base station 53. The base station wirelessly transmits the information to the graphical dedicated receiving unit 54.

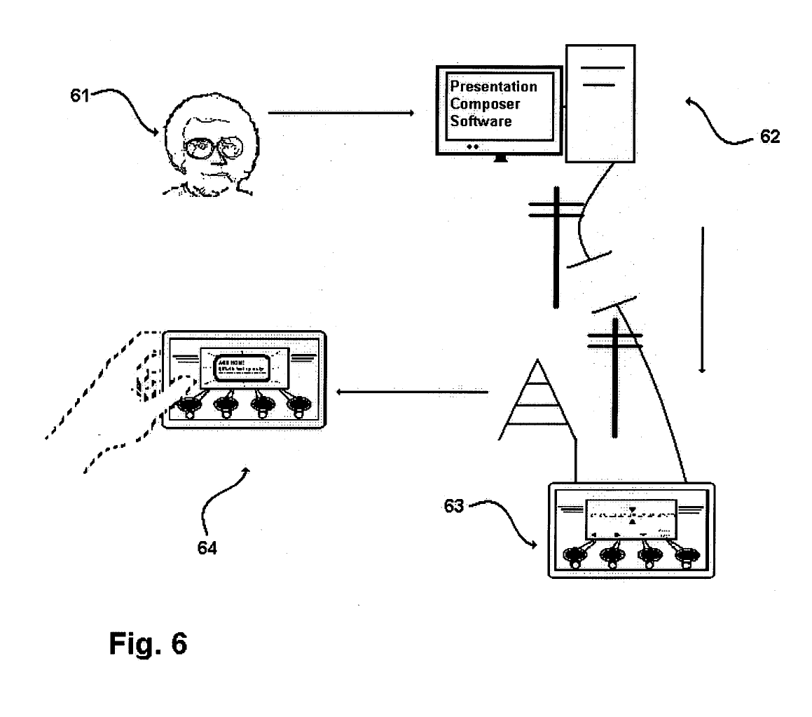

FIG. 6 is a schematic representation of the typical flow of information for images and sound from the mind of the presentation developer to the graphical dedicated receiving units in which the computer running the presentation composing software and the base station of the patron paging system are connected remotely by telephone lines. Referring to FIG. 6, the straight arrows represent the flow of information. The presentation developer 61 composes the images and sounds or imports images and sound stored in other formats. This information transfer is accomplished by normal means such as keystrokes and mouse movements and clicks. The developer selects the mode (e.g. peeling) for each screen-slide change. Once the information is formatted correctly by the computer 62 running the composer software, the information is transferred from the computer to the base station 63 by way of a phone line connection to the modem of the base station. The base station wirelessly transmits the information to the graphical dedicated receiving unit 64.

It is specifically envisioned that the system disclosed here could be part of a more complex system. For example, a complex system might allow some patrons to be notified using a non-dedicated communications device (such as a cell phone) when it is time for them to be seated. The same complex system might allow other patrons to be notified by a graphical dedicated receiving unit when it is time for them to be seated. In complex systems, the “local wireless communication system” refers to the subsystem meeting the previously stated definition.

The system described above could find many uses. However, the preferred use is in a restaurant setting. Patrons who are asked to wait for seating would be lent graphical dedicated receiving units. The establishment would determine what screen-slides would be displayed. By way of example, an establishment may elect to have certain screen-slides which are displayed automatically starting when the graphical dedicated receiving unit is issued to a patron. Those screen-slides might include information about how to use the graphical dedicated receiving unit, general information about the establishment, current information about the establishment (e.g., “specials” offered at a restaurant). Those screen-slides could be followed by a looping presentation of screen slides. Those screen-slides could include images principally intended to keep the attention of the patron by entertaining. Those screen-slides could also include marketing messages. Those marketing messages could be to promote the establishment employing the system or to promote other establishments. For example, a restaurant employing the system might include screen-slides with information about nearby stores, museums and theatres. This ability to deliver marketing messages could make the system a revenue generator for the establishment employing it either by self promotion or because the establishment could charge other establishments for the advertising.

The advertising revenue generating potential of the system could allow for establishments to be given, sold, lent the system or leased the system at reduced cost in exchange for the conveyor (giver, seller, lender or lessor) having advertising rights. Those advertising rights may be transferable.

1. A graphical dedicated receiving unit.

2. A unit as in claim 1 in which the unit is a transceiver.

3. A unit as in claim 1 in which the graphical display is has not less than 20 pixels in each of two dimensions.

4. A patron paging system including at least one graphical dedicated receiving unit.

5. A system as in claim 4 in which at least one graphical dedicated receiving unit has an electronic serial number for unique identification which allows signals from the base to be used selectively by less than all of the portable units.

6. A system as in claim 4 in which at least one graphical dedicated receiving unit is powered by at least one electrochemical cell.

7. A system as in claim 4 in which at least one graphical dedicated receiving unit has means for the user to cause the portable unit to send a radio frequency signal and the base is capable of receiving that signal.

8. A system as in claim 7 in which said means is a pressure sensing switch.

9. A system as in claim 4 in which at least one graphical dedicated receiving unit has sufficient memory to hold more graphical information than is displayed at a given time.

10. A system as in claim 4 in which at least one graphical dedicated receiving unit is capable of synthesizing the frequency at which it receives signals.

11. A system as in claim 4 in which each graphical dedicated receiving unit displays at least one preset message when that unit is out of the range of the signal of the base.

12. A use of a system as in claim 4 in which at least one marketing message is displayed on the graphical display of at least one graphical dedicated receiving unit.

13. A use as in claim 12 in which at least one marketing message displayed on the graphical display of at least one graphical dedicated receiving unit promotes the establishment employing the system.

14. A use as in claim 12 in which at least one marketing message displayed on the graphical display of at least one graphical dedicated receiving unit promotes the establishment other than that employing the system.

15. A use as in claim 12 in which the establishment using the system is a restaurant.

16. A use as in claim 12 in which the conveyor of the system is compensated, at least in part, by rights involving advertising using the system.

17. A unit as in claim 2 in which said unit is capable of dynamically adjusting its transmission power.

18. A unit as in claim 17 in which the dynamic adjustment of the transmission power is based, at least in part, on the strength of signals sent by the base station and received by the unit.

19. A unit as in claim 1 which is capable of creating at least two readily distinguishable sounds.

20. A dedicated receiving unit in which said unit is capable of dynamically adjusting its transmission power, wherein, that dynamic adjustment of the transmission power is based, at least in part, on the strength of signals sent by the base station and received by the unit.
